(19) United States
(12) Patent Application Publication
(10) Pub. No.: US 2015/0243158 A1
(43) Pub. Date: Aug. 27, 2015

(54) METHOD FOR FINDING OBJECTS

(71) Applicant: Pixie Technology, Inc., Los Altos, CA (US)

(72) Inventors: Amir Bassan-Eskenazi, Los Altos, CA (US); Eran Aharonson, Ramat Hasharon (IL); Ofer Friedman, Ganei-Tikva (IL)

(21) Appl. No.: 14/613,382

(22) Filed: Feb. 4, 2015

Related U.S. Application Data
(60) Provisional application No. 61/936,340, filed on Feb. 6, 2014.

(51) Int. Cl. G08B 21/24; G06T 19/00

(52) U.S. Cl. CPC G08B 21/24; G06T 19/006

(57) ABSTRACT

A method, that may include determining, by a wireless reader, at least one locations of at least one wireless tag; determining, by a mobile device, which wireless tag out of the at least one wireless tag is a viewable wireless tag that is within a field of view of a camera of the mobile device; wherein the mobile device is either coupled to the wireless reader or comprises the wireless reader; and providing, by the mobile device, for each viewable wireless tag, a viewable wireless tag indication that is indicative of a location of each viewable wireless tag.

### RELATED APPLICATIONS

This application claims priority from U.S. provisional patent No. 61/936,340 filing date Feb. 6, 2014.

### BACKGROUND OF THE INVENTION

Modern houses usually include a large number of objects including but not limited to static objects and mobile objects such as electronic devices, furniture, books, and the like.

Looking for an object may be a time consuming task.

There is a growing need to locate objects such as mobile phones, keys, media players, and the like.

### SUMMARY

In an embodiment of the present invention, a method may be provided and may include determining, by a wireless reader, at least one locations of at least one wireless tag; determining, by a mobile device, which wireless tag out of the at least one wireless tag may be a viewable wireless tag that may be within a field of view of a camera of the mobile device; wherein the mobile device may be either coupled to the wireless reader or may include the wireless reader; and providing, by the mobile device, for each viewable wireless tag, a viewable wireless tag indication that may be indicative of a location of each viewable wireless tag.

The viewable wireless tag indication may be a visual indication.

The method may include augmenting an image captured by the camera with each viewable wireless tag indication to provide an augmented image.

At least one parameter of a viewable wireless tag indication may be indicative of distance between the mobile device and a wireless tag associated with the viewable wireless tag indication.

At least one parameter of a shape, color, and size of viewable wireless tag indication may be indicative of distance between the mobile device and a wireless tag associated with the viewable wireless tag indication.

The field of view of the camera corresponds to an angular area; wherein the method may include determining, by the mobile device, which wireless tag out of the at least one wireless tag may be an external wireless tag that may be outside the angular area.

The method providing, by the mobile device, for each external wireless tag, an external wireless tag indication that may be indicative of a location of each external wireless tag.

The external wireless tag indication points to a spatial relationship between the field of view of the camera and a location of each external wireless tag.

The external wireless tag indication differs from the viewable wireless tag indication.

The field of view of the camera corresponds to an angular area; wherein the method may include determining, by the mobile device, which wireless tag out of the at least one wireless tag may be a hidden wireless tag that may be within the angular area but may be behind an obstacle.

The obstacle may be a wall.

The determining may include processing an image acquired by the camera to locate the obstacle.

The method may include providing, by the mobile device, for each hidden wireless tag, a hidden wireless tag indication that may be indicative of a location of each hidden wireless tag.

The method may include generating information regarding the at least one location of the at least one obstacle by acquiring, by the camera, multiple images when the camera may be positioned in at least one out of at different locations and different orientations; processing the images to detect the at least one obstacle, wherein the processing of an image of the images may be responsive to a location and an orientation of the camera when the camera acquired the image.

The field of view of the camera corresponds to an angular area; wherein the method may include determining, by the mobile device, which wireless tag out of the at least one wireless tag may be a hidden wireless tag that may be within the angular area but may be behind an obstacle that may be within the field of view of the camera.

The hidden wireless tag indication differs from the viewable wireless tag indication.

The method may include transmitting, by the wireless reader, a transmitted signal to a certain wireless tag of the at least one wireless tags; receiving a response signal from the certain wireless tag; and processing the response signal to determine whether the wireless tag may be a hidden wireless tag.

The processing may include calculating a first distance estimate in response to a timing difference between the transmitting and the receiving; calculating a second distance estimate in response to a strength parameter difference between the transmitted signal and the response signal; and comparing between the first and second distance estimate.

The field of view of the camera corresponds to an angular area; wherein the method may include generating polar representation of the at least one locations of at least one wireless tag.

The method may include classifying each wireless tag of one of the at least one wireless tag in response to a relationship between the angular area and an angle between the wireless tag and an optical axis of the camera.

The method may include augmenting an image captured by the camera with each viewable wireless tag indication to provide an augmented image; wherein a position of each viewable wireless tag indication within the augmented image may be responsive to (a) a distance between the camera and a wireless tag associated with the viewable wireless tag indication, and (b) an angle between an optical axis of the camera and a location of the viewable wireless tag.

The method further may include providing at least one out-of-sight image indication that may be indicative of at least one image of at least one out-of-sight area that may be outside the field of view of the camera; receiving a request to retrieve a certain out-of sight image and displaying the certain out-of-sight image.

The method may include augmenting an image that corresponds to the field of view of the camera with the out-of-sight image indication.

a position of each out-of-sight image indication within the augmented image may be responsive to an angle between an optical axis of the camera and a location of the out-of-sight area.

The viewable wireless tag indication may be indicative of an accuracy of an estimation of the location of the viewable wireless tag.

Further embodiments of the invention include a computer readable medium that is non-transitory and may store instructions for performing the above-described methods and any steps thereof, including any combinations of same. For example, the computer readable medium may store instructions for execution by one or more processors or similar mobile devices, which instructions, when executed, result in, cause or facilitate to determine, based upon wireless communication between a wireless reader of the mobile device and at least one wireless tag, at least one locations of the least one wireless tag; determine which wireless tag out of the at least one wireless tag is a viewable wireless tag that is within a field of view of a camera of the mobile device; and providing, by the mobile device, for each viewable wireless tag, a viewable wireless tag indication that is indicative of a location of each viewable wireless tag.

According to an embodiment of the invention there may be provided a mobile device that may include a processor, a wireless reader, a camera and an interface; wherein the warless reader is configured to communicate with at least one wireless tag; wherein the device is configured to determine, based upon the communication, at least one location of the least one wireless tag; wherein the processor is configured to determine which wireless tag out of the at least one wireless tag is a viewable wireless tag that is within a field of view of a camera of the mobile device; and wherein the interface is configured to provide, for each viewable wireless tag, a viewable wireless tag indication that is indicative of a location of each viewable wireless tag.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates method according to an embodiment of the invention;

FIG. 2 illustrates first till sixth wireless tags and a mobile device according to an embodiment of the invention;

FIG. 3 illustrates a polar map of multiple tags and the field of view of camera of the device according to an embodiment of the invention;

FIG. 4 illustrates an augmented image according to an embodiment of the invention;

FIG. 5 illustrates an augmented image according to an embodiment of the invention;

FIG. 6 illustrates a polar map in which a sixth wireless tag is positioned within the angular area that corresponds to the field of view of the camera but is hidden by obstacle according to an embodiment of the invention;

FIG. 7 illustrates an augmented image that includes a hidden wireless tag indication indicative of the sixth wireless tag according to an embodiment of the invention;

FIG. 8 illustrates an identification of the wall by the device according to an embodiment of the invention;

FIG. 9 illustrates a person, the imaginary horizon, the optical axis, a floor and a viewable wireless tag according to an embodiment of the invention;

FIG. 10 illustrates a map of a house according to an embodiment of the invention.

FIG. 11 illustrates an augmented image according to an embodiment of the invention; and

FIG. 12 illustrates pulses of a response signal according to an embodiment of the invention.

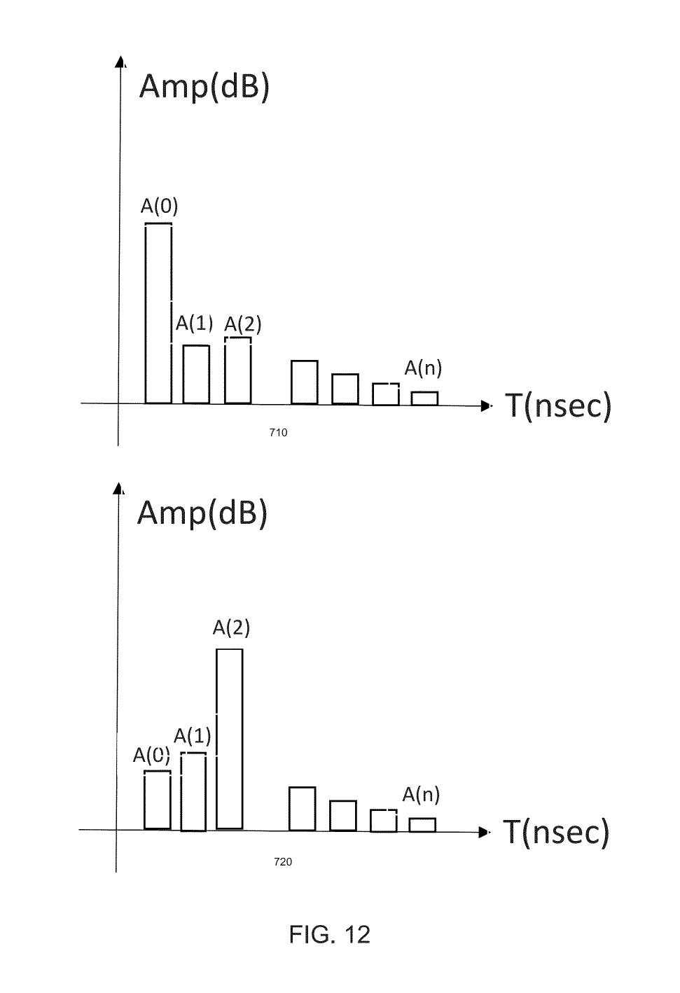

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

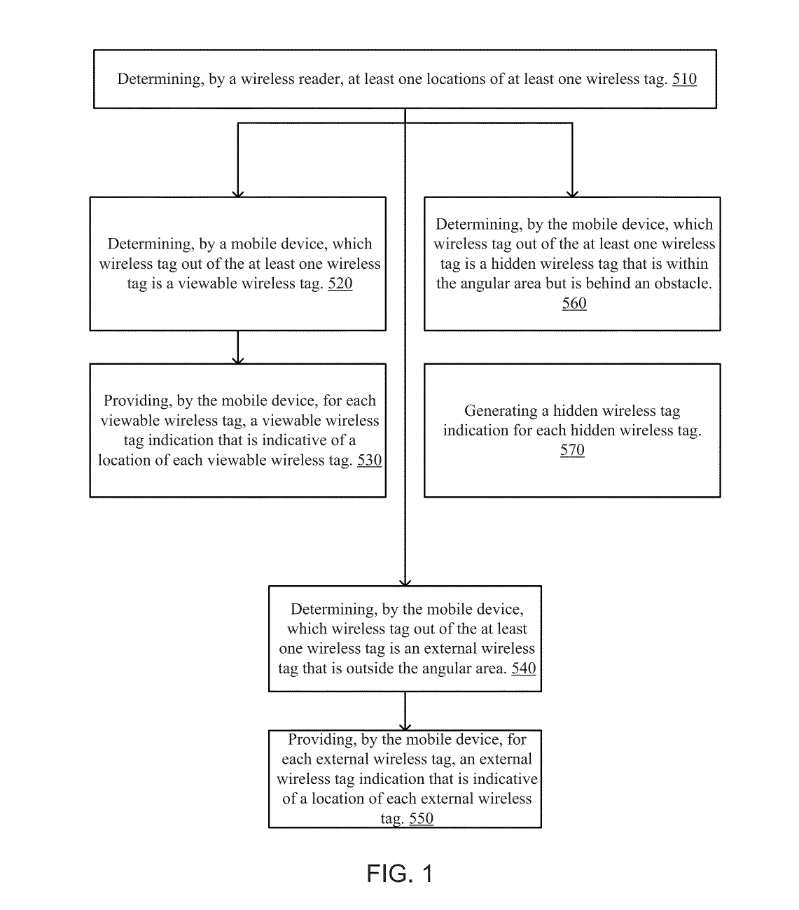

FIG. 1 illustrates method 500 according to an embodiment of the invention.

Method 500 may start by stage 510 of determining, by a wireless reader, at least one locations of at least one wireless tag. The wireless reader is configured to communicate with wireless tags. Additionally or alternatively, the wireless tags may communicate with each other. The determination of the location may be executed, for example, by using one or more methods illustrated in U.S. patent application Ser. No. 14/085,847 and/or in U.S. patent application Ser. No. 14/085,849, both incorporated herein by reference.

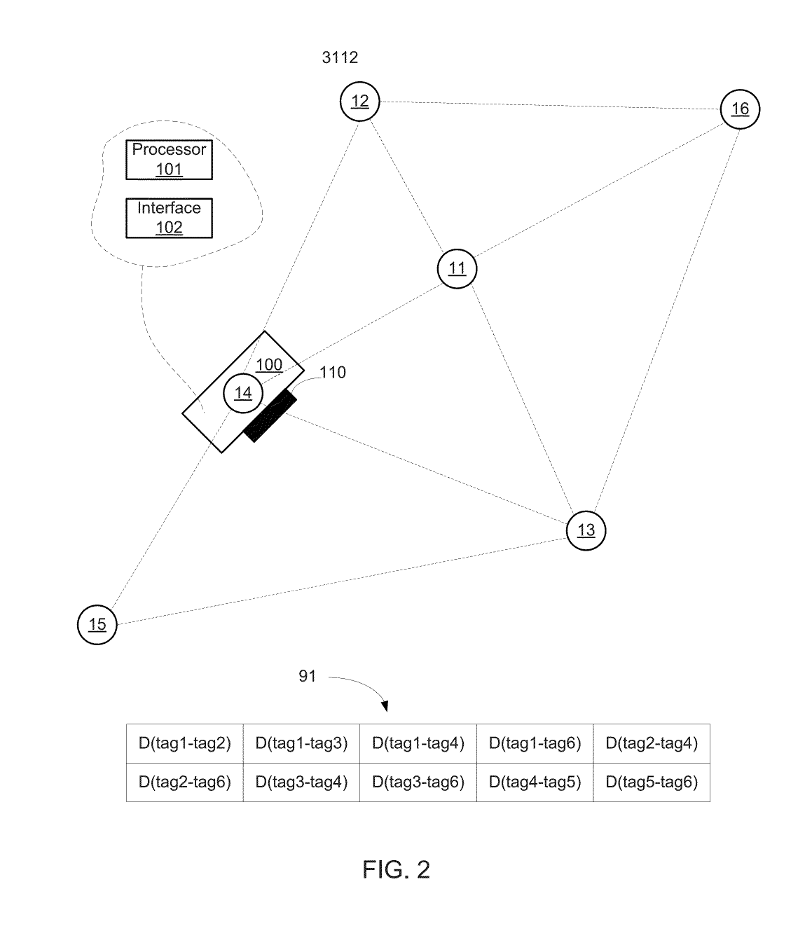

FIG. 2 illustrates a non-limiting example of first till sixth wireless tags 11, 12, 13, 14, 15 and 16, wherein the fourth wireless tag 14 is coupled to mobile device 100. Mobile device 100 is also illustrated as including processor 101 and interface 102 such as a display. The mobile device 100 may communicate with fourth wireless tag 14 and may execute code that will enable the combination of the mobile device 100 and fourth wireless tag 14 to operate as a wireless reader. Alternatively, a wireless reader may be attached to the mobile phone.

The fourth wireless tag 14 may be a part of a wireless reader or may be replaced by a wireless reader. Mobile device 100 is illustrated as including camera 100. The distances between each pairs of tags are illustrated by dashed lines that connect each pair of wireless tags. A data structure 91 may be maintained by device 100 and may store the distances between pairs of tags. The distances between the tags are denoted D(tag1-tag2), D(tag1-tag3), D(tag1-tag4), D(tag1-tag6), D(tag2-tag4), D(tag2-tag6), D(tag3-tag4), D(tag3-tag6), D(tag4-tag5) and D(tag5-tag6). D(tag1-tag2) represents the distance between first and second tags 11 and 12. The distances may be kept in any other format.

Referring back to FIG. 1—stage 510 may be followed by stage 520 of determining, by a mobile device, which wireless tag out of the at least one wireless tag is a viewable wireless tag. A viewable wireless tag is a wireless tag that is within a field of view of a camera of the mobile device. The mobile device is either coupled to the wireless reader or comprises the wireless reader.

Stage 520 may include generating a polar representation of the at least one locations of at least one wireless tag.

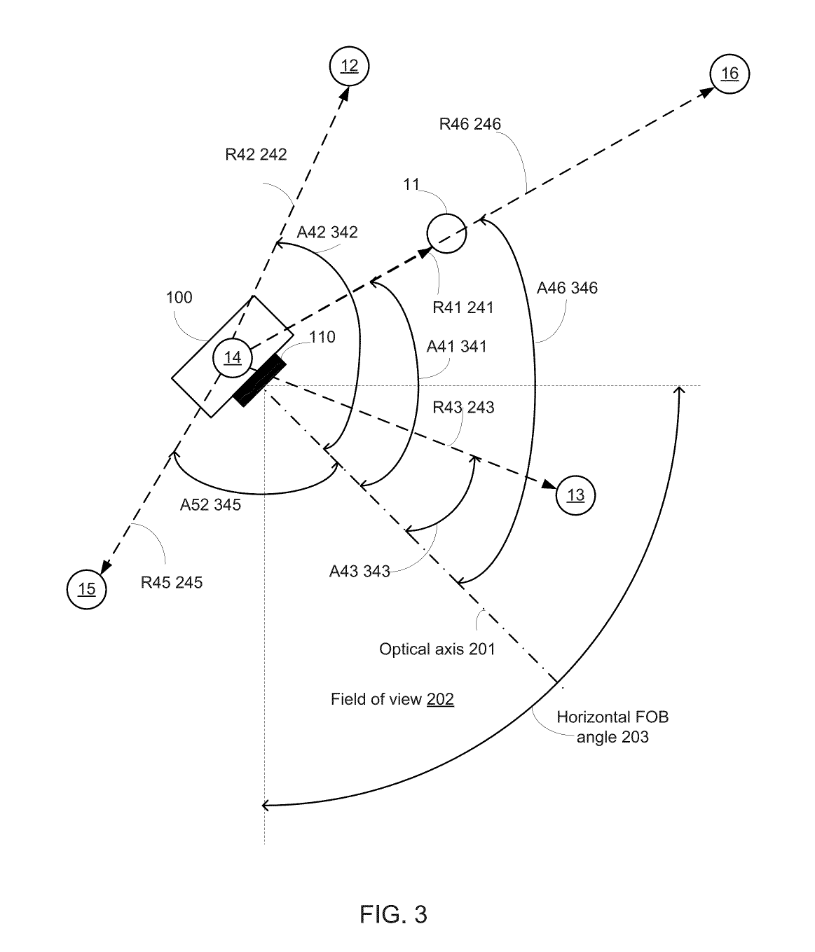

Referring to FIG. 3—the distances between the different wireless tags are converted to a polar representation (angle and radius) of the spatial relationship between mobile device 100 and the locations of wireless tags 11, 12, 13, 15 and 16—R41 241, R42 242, R43 243, R45 245 and R46 246 and A41 341, A42 342, A43 343, A45 345 and A46 346 represent the distance (radius) and angle of wireless tags 11, 12, 13, 15 and 16 respectively from device 100. FIG. 3 also illustrates the field of view 202 and the optical axis 201 of camera 110 of device.

The optical axis 201 of the device may be determined by the device by using, for example, orientations sensors such as an e-compass and accelerometers.

It can be clearly seen that third wireless tag 13 is within the field of view of camera (assuming, for simplicity of explanation) that it is not hidden by an obstacle. The obstacle may be an object that is opaque or substantially opaque to wireless communication radiation that is used during wireless communication with a wireless tag.

Stage 520 may be followed by stage 530 of providing, by the mobile device, for each viewable wireless tag, a viewable wireless tag indication that is indicative of a location of each viewable wireless tag.

The viewable wireless tag indication may be a visual indication, an audio indication or both.

For simplicity of explanation it is assumed that the viewable wireless tag indication is a visual indication and that stage 530 includes augmenting an image captured by the camera with each viewable wireless tag indication to provide an augmented image.

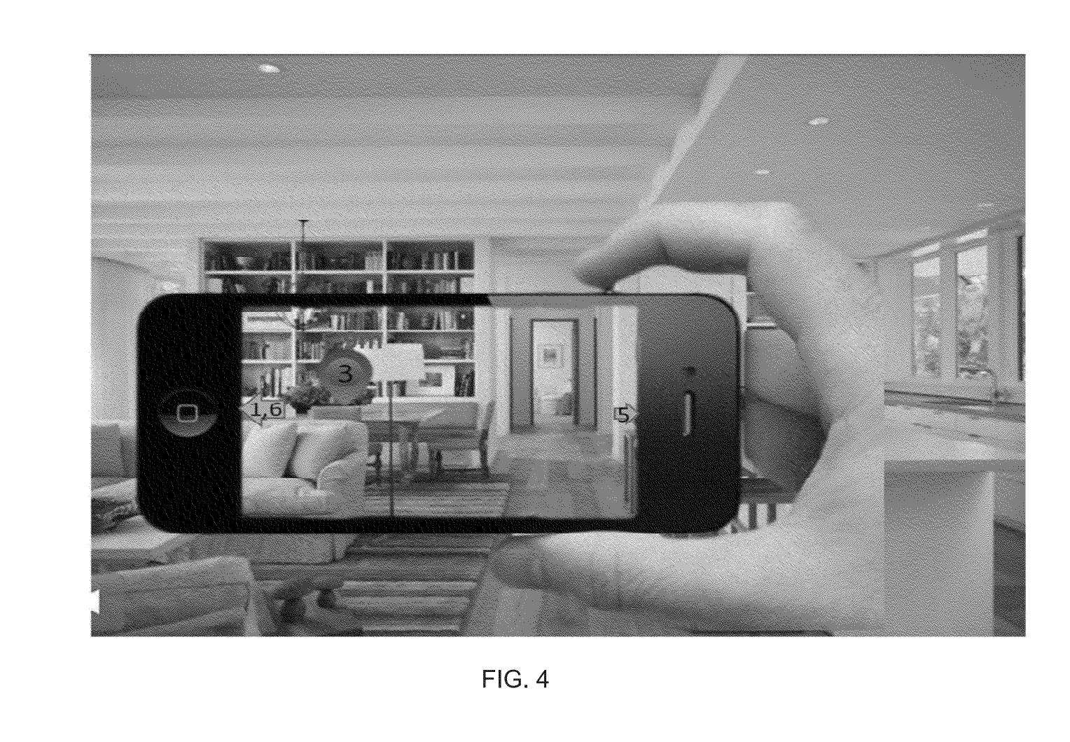

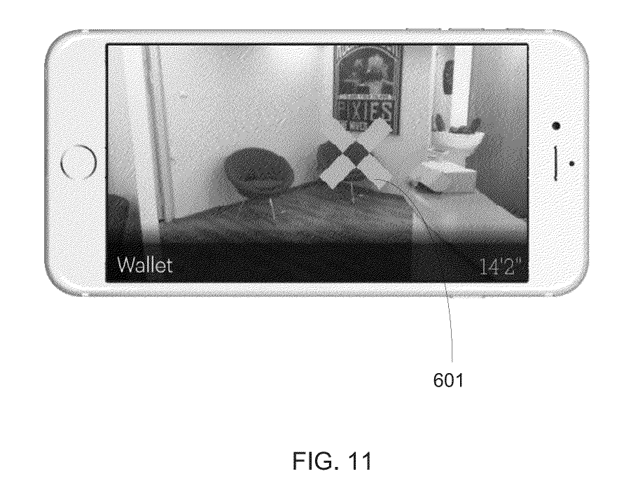

FIG. 4 illustrates a device that displays an augmented image that includes an on line or pre-stored image of a room as well as a viewable wireless tag indication that is indicative of a location of third wireless tag 13. FIG. 11 illustrates an augmented image that includes an image of a room as well as a viewable wireless tag indication that is has a central aperture that corresponds to the location of the wireless tag. The pre-stored image should be stored with location information that is indicative of where the camera was positioned when the pre-stored image was acquired. This or other type of information will enable the device to estimate the field of view of the camera when the pre stored image was acquired and to provide the augmented image.

According to an embodiment of the invention at least one parameter of a viewable wireless tag indication (such as bot not limited to brightness, color, size or shape) is indicative of distance between the mobile device and a wireless tag associated with the viewable wireless tag indication. For example—the viewable wireless tag indication visibility can decrease with distance from the device.

According to an embodiment of the invention the field of view of the camera corresponds to an angular area. For example—assuming a rectangular field of view—the angular area may be characterized by two orthogonal angles of view. The method may detect which wireless tags are outside the angular area.

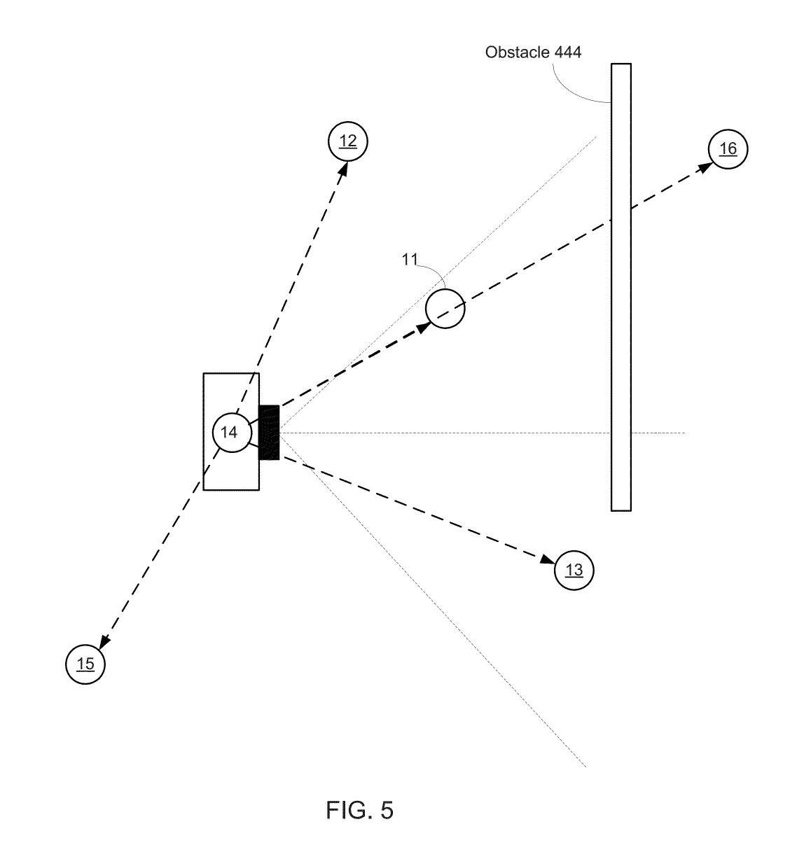

Yet according to another embodiment of the invention the viewable wireless tag indication is indicative of an accuracy of an estimation of the location of the viewable wireless tag. See, for example FIG. 5 in which the viewable wireless tag indication includes concentric rings—and the number of rings is indicative of the accuracy.

Referring to FIG. 1—stage 510 may be followed by stage 540 of determining, by the mobile device, which wireless tag out of the at least one wireless tag is an external wireless tag that is outside the angular area.

Stage 540 may be followed by stage 550 of providing, by the mobile device, for each external wireless tag, an external wireless tag indication that is indicative of a location of each external wireless tag.

The external wireless tag indication may point to a spatial relationship between the field of view of the camera and a location of each external wireless tag.

The external wireless tag indication may differ from (or may be equal to) the viewable wireless tag indication.

Referring to FIG. 4—the augmented image includes a right external wireless tag indication that is shaped as an arrow and points to the right edge of the augmented image. The right external wireless tag indication points to the fifth wireless tag 15. The augmented image also includes one or more left external wireless tag indication that is shaped as an arrow and points to the left edge of the augmented image. The one or more left external wireless tag indication points to the first and sixth wireless tags 11 and 16.

According to an embodiment of the invention the angular area may “cover” objects that would have been within the field of view of the camera if they were not located behind obstacles. The method may detect hidden objects that are within the angular area but are hidden.

It is noted that the wireless tag may wirelessly communicate with the wireless reader by using wireless communication electromagnetic radiation (such as radio frequency radiation). This wireless communication electromagnetic radiation may penetrate through some obstacles (such as pillows or other objects that are substantially transparent to electromagnetic radiation) that are regarded as substantially transparent to wireless communication electromagnetic radiation—and within the line of sight of the wireless reader. An object that is substantially transparent to wireless communication electromagnetic radiation may be regarded as opaque or substantially opaque to light—and thus may hide the wireless tag from the camera. It is assumed that a wireless tag is regarded as a viewable wireless tag if it is within the field of view of the camera and is hidden by an object that is substantially transparent to wireless communication electromagnetic radiation.

Referring to FIG. 1—stage 510 may be followed by stage 560 of determining, by the mobile device, which wireless tag out of the at least one wireless tag is a hidden wireless tag that is within the angular area but is behind an obstacle.

The obstacle may be a wall. Stage 560 may include processing an image acquired by the camera to locate the obstacle.

Stage 560 may be followed stage 570 of generating a hidden wireless tag indication for each hidden wireless tag.

The hidden wireless tag indication may be equal to or may differ from the viewable wireless tag indication.

Stage 560 may include: (a) transmitting, by the wireless reader, a transmitted signal to a certain wireless tag of the at least one wireless tags; (b) receiving a response signal from the certain wireless tag; and (c) processing the response signal to determine whether the wireless tag is a hidden wireless tag.

The processing may include: (a) calculating a first distance estimate in response to a timing difference between the transmitting and the receiving; (b) calculating a second distance estimate in response to a strength parameter difference between the transmitted signal and the response signal; and (c) comparing between the first and second distance estimate. The strength parameter may be the power and/or intensity of the signal, a signal to noise ratio, a RSSI measurement, and the like. If the tag is not hidden after an obstacle and assuming that the initial strength of the response (as outputted by the certain wireless tag) is known, its strength (as received by the wireless reader) should be a ratio between the initial strength of the response and a square of the distance between the certain wireless tag and the wireless reader.

According to an embodiment of the invention that transmitted signal includes a pulse of a certain frequency and the response may include a set of pulses resulting from direct propagation as well as indirect (multipath) propagation. If, for example the first pulse of the set is not the strongest pulse then it may be assumed that it is a result of a multipath and that the certain wireless tag is a hidden wireless tag. If the first pulse of the set of pulses is the strongest pulse then the method may compare between its timing and strength parameters.

According to an embodiment of the invention the device measures time of flight of packets. Given a channel transfer function is the time domain within a resolution that is proportional to the bandwidth of the transmission. The resolution may be, for example, 1 nsec. Graph 710 shows the case where the first path is also the strongest. This is typical to line-of-sight (LOS) scenario but does not mandates LOS

Graph 720 shows the case where the first path is not the strongest (A(2)>A(0))

In such scenario we determine that the wireless tag is behind an obstacle and draw is dashed, since a reflection (A(2)) is stronger than the direct path (A(0)), meaning the direct path is blocked

If A(0) is the strongest, we compare the if its amplitude match a free path signal lost according to:

R=Pₜ+Gₜₒₜ−L

L_{fs}=32.45+20 Log₁₀(dₖₘ)+20 Log₁₀(f_{MHz})

Pt (the transmitted power) is known and so is the total antenna gains (Gtot). For calculating L, the frequency is known and we use the distance estimation d from the ToF measurement. So we have the expected R according to the estimated distance, and we compare it to the received signal strength of the first path. If the received signal strength is lower than the estimation, we can expect to have an obstacle between the mobile device and the wireless tag (since it attenuates the signal strength).

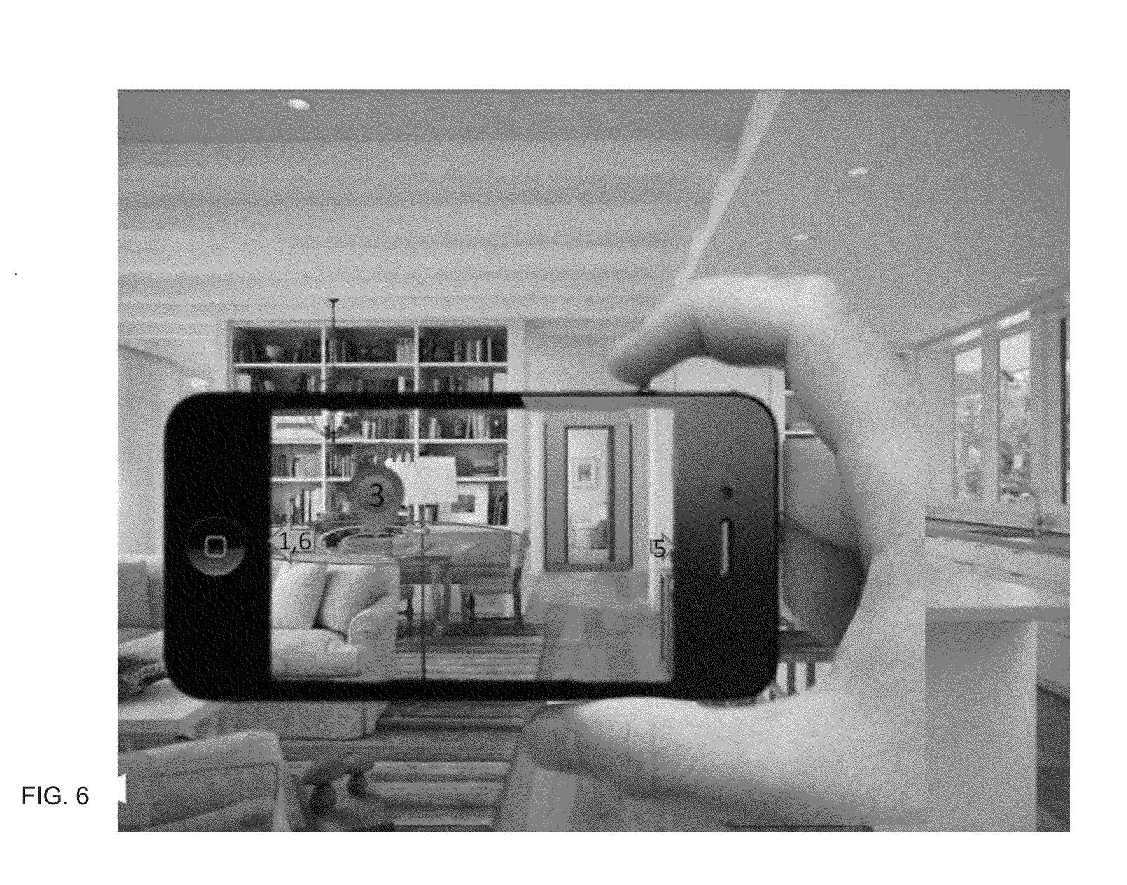

FIG. 6 illustrates a polar map in which the sixth wireless tag 16 is positioned within the angular area that corresponds to the field of view of the camera but is hidden by obstacle 444.

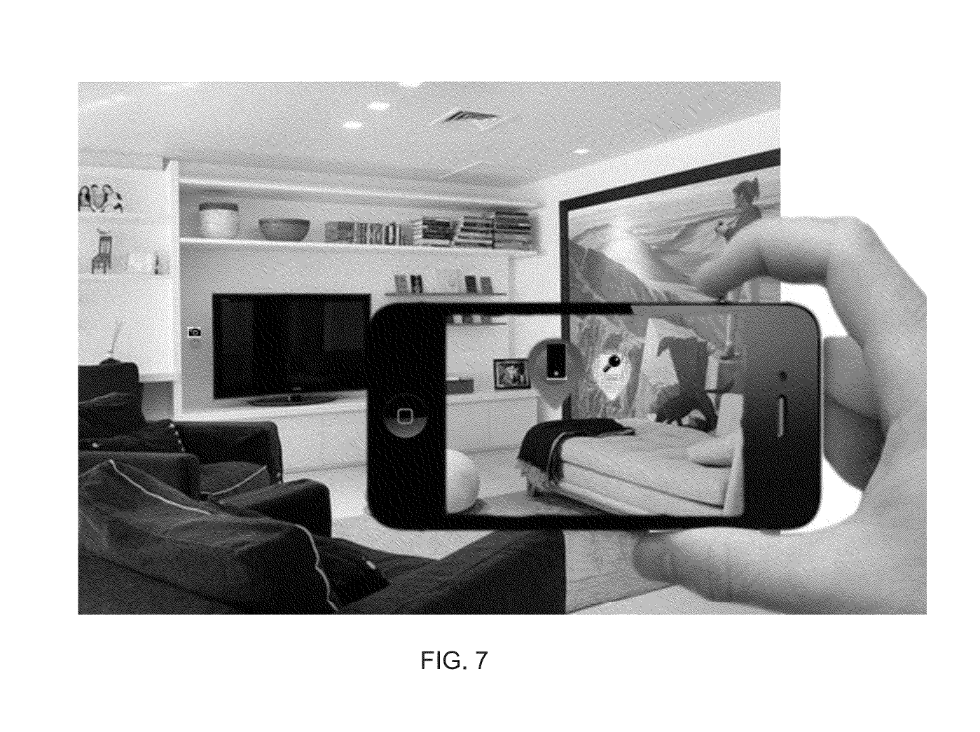

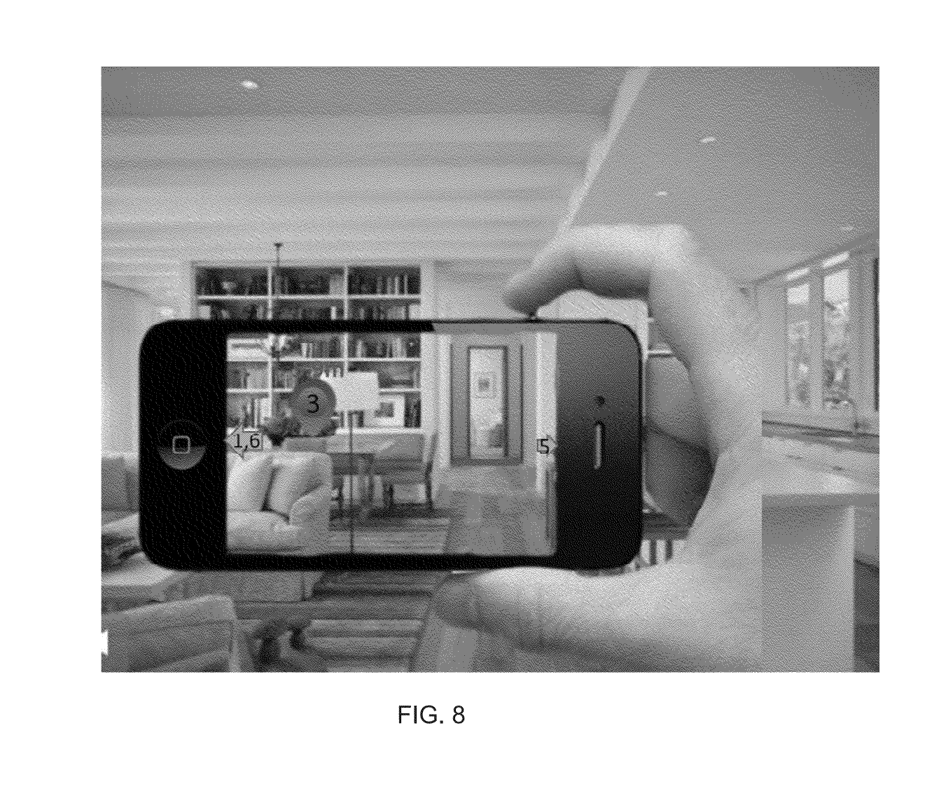

FIG. 7 illustrates an augmented image that includes a hidden wireless tag indication indicative of the sixth wireless tag 16. FIG. 8 illustrates an identification of the wall by the device.

According to an embodiment of the invention the generation of the augmented image includes determining where to position a wireless tag indication (especially hidden wireless tag indication and viewable wireless tag indication) so that is points to the wireless tag.

This may include calculating the relationship between the optical axis of the camera and the locations of the wireless tags.

Assuming that the optical axis corresponds to a center point of the field of view and that there is an imaginary horizon of the field of view that is located at the center of the field of view then indicators of wireless tags that are below that imaginary horizon should be positioned below the center of the augmented image and indicators of wireless tags that are above that imaginary horizon should be positioned above the center of the augmented image.

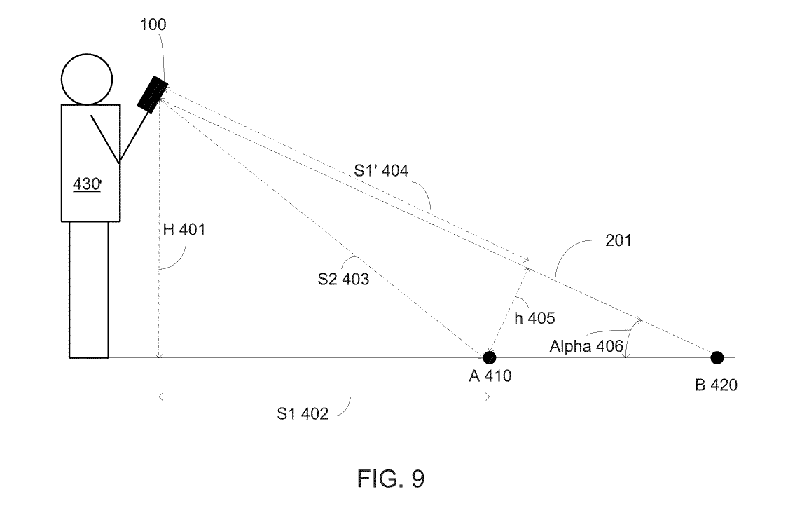

FIG. 9 illustrates a person, the imaginary horizon, the optical axis, a floor and a viewable wireless tag according to an embodiment of the invention.

Person 403 holds device 100 at a certain height H 401 and directs the device 100 so that the camera is tilted towards a floor. The optical axis 201 of the camera intersects with the floor at an imaginary horizon B 420 and forms an angle (alpha 406) with the floor. Height H 401 may be measures or estimated (it may be fed by a user or may be set to a default value of about 160 cm). A viewable wireless tag A 410 is located at a distance S1 402 from the feet of person 430 and at a distance S2 403 from the device 100. Distance S2 403 is measured by device 100.

The viewable wireless tag A 410 should be represented by a viewable wireless tag indication that should be positioned below the center of the augmented image—by a distance that should reflect the distance h 405 between the viewable wireless tag A 410 and the optical axis 201.

The camera has a focal point (f) that may correspond to the distance between the camera and imaginary horizon B 420.

FIG. 9 also shows a distance S1′ between the camera and certain point on the optical axis 201. An imaginary normal h is normal to the optical axis 201 and extends from viewable wireless tag A to the certain point.

In general:
a. h=H*cosine(Alpha)−S1*sinus(Alpha).
b. S1′=H*sinus(Alpha)+S1*cosine(Alpha).

According to an embodiment of the invention method 500 may also include stage 580 of providing at least one out-of-sight image indication. An out-of-sight indication is indicative of at least one image of at least one out-of-sight area that is outside the field of view of the camera; receiving a request to retrieve a certain out-of sight image and displaying the certain out-of-sight image.

Stage 580 may include augmenting an image that corresponds to the field of view of the camera with the out-of-sight image indication.

The position of each out-of-sight image indication within the augmented image is responsive to an angle between an optical axis of the camera and a location of the out-of-sight area.

The images of the out-of-sight areas may be generated by device and/or fed to the device. The locations of such images may be calculated by the device (when the device acquired the images) or be fed to the device.

The device knows where it is positioned and may determine the spatial relationships between the locations of the out-of-sight areas and the location of the device and may provide out-of-sight image indications that are positioned in the augmented image in a manner that reflects the spatial relationships.

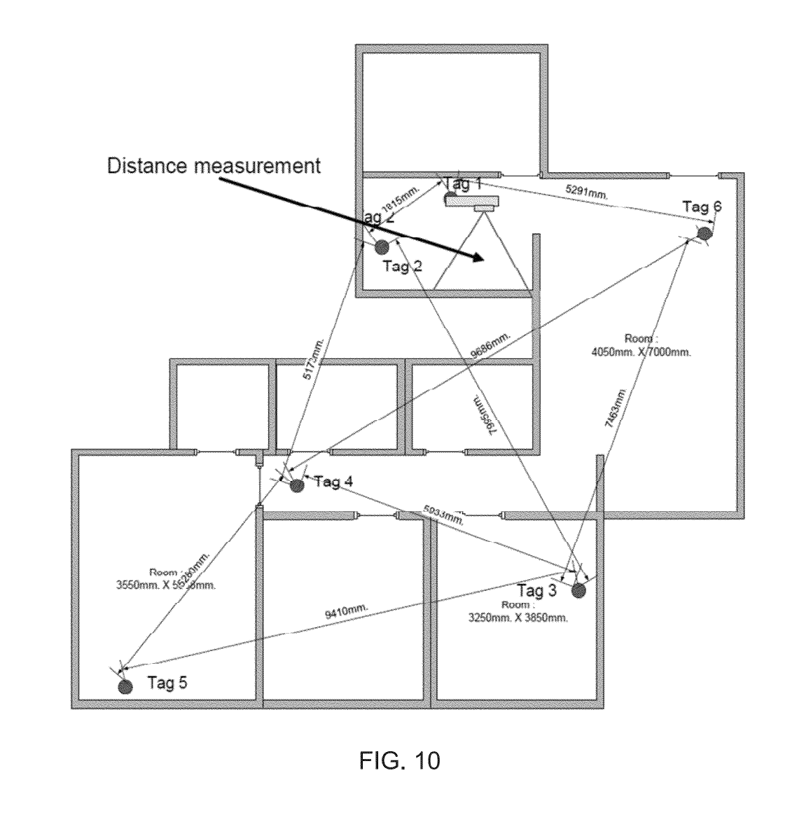

According to an embodiment of the invention the device may be used for mapping an environment. A map is illustrated in FIG. 10.

A user may carry a mobile device within a wireless reader. In each room the user takes a photo of the walls, the mobile device measures the distances to the walls. Every distance measurement has a timestamp and an e-compass reading

Since the user carries a wireless tag, and assuming there are more wireless tags which are static during the procedure (two if they are along a wall, three in the general case) the mobile device can calculate the positions of the user for each distance measurement.

So at each position the user took measurement, the mobile device has the position, the distance and the direction of the measurement. Hence, it has all the information needed to stitch the distance measurements together and create a map of the site the measurements were taken.

The same method can be implemented as a background process to method 500. As the user uses the mobile device, the mobile device identifies walls location, stores them and is able to build the map over time\

Once a picture of the wall/room is taken, the mobile device can use it as a virtual “anchor” for future use. On a later occasion, when the mobile device tries to locate the user, it can use image processing techniques to identify the room and also identify the distance and angle of the current view compared to previous view. This information can be used to reduce errors in the case where the user carries a tag or to be used as the main source of information to locate a user if he/she does not carry a tag.

The invention may also be implemented in a computer program for running on a computer system, at least including code portions for performing steps of a method according to the invention when run on a programmable apparatus, such as a computer system or enabling a programmable apparatus to perform functions of a mobile device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) mobile devices. When executing the computer program, the computer system processes information according to the computer program and produces resultant output information via I/O mobile devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or mobile devices, for example via intermediate mobile devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connections that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same mobile device. Alternatively, the examples may be implemented as any number of separate integrated circuits or separate mobile devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical mobile devices or units implemented in non-programmable hardware but can also be applied in programmable mobile devices or units able to perform the desired mobile device functions by operating in accordance with suitable program code, such as mainframes, minicomputers, servers, workstations, personal computers, notepads, personal digital assistants, electronic games, automotive and other embedded systems, cell phones and various other wireless mobile devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method, comprising:
determining, by a wireless reader, at least one locations of at least one wireless tag;
determining, by a mobile device, which wireless tag out of the at least one wireless tag is a viewable wireless tag that is within a field of view of a camera of the mobile device; wherein the mobile device is either coupled to the wireless reader or comprises the wireless reader; and
providing, by the mobile device, for each viewable wireless tag, a viewable wireless tag indication that is indicative of a location of each viewable wireless tag.

2. The method according to claim 1 wherein the viewable wireless tag indication is a visual indication.

3. The method according to claim 1 comprising augmenting an image captured by the camera with each viewable wireless tag indication to provide an augmented image.

4. The method according to claim 1 wherein at least one parameter of a viewable wireless tag indication is indicative of distance between the mobile device and a wireless tag associated with the viewable wireless tag indication.

5. The method according to claim 1 wherein at least one parameter of a shape, color, and size of viewable wireless tag indication is indicative of distance between the mobile device and a wireless tag associated with the viewable wireless tag indication.

6. The method according to claim 1 wherein the field of view of the camera corresponds to an angular area; wherein the method comprises determining, by the mobile device, which wireless tag out of the at least one wireless tag is an external wireless tag that is outside the angular area.

7. The method according to claim 6 providing, by the mobile device, for each external wireless tag, an external wireless tag indication that is indicative of a location of each external wireless tag.

8. The method according to claim 7 wherein the external wireless tag indication points to a spatial relationship between the field of view of the camera and a location of each external wireless tag.

9. The method according to claim 8 wherein the external wireless tag indication differs from the viewable wireless tag indication.

10. The method according to claim 6 wherein the field of view of the camera corresponds to an angular area; wherein the method comprises determining, by the mobile device, which wireless tag out of the at least one wireless tag is a hidden wireless tag that is within the angular area but is behind an obstacle.

11. The method according to claim 10 wherein the obstacle is a wall.

12. The method according to claim 10 wherein the determining comprises processing an image acquired by the camera to locate the obstacle.

13. The method according to claim 10 comprising providing, by the mobile device, for each hidden wireless tag, a hidden wireless tag indication that is indicative of a location of each hidden wireless tag.

14. The method according to claim 13 comprising generating information regarding the at least one location of the at least one obstacle by acquiring, by the camera, multiple images when the camera is positioned in at least one out of at different locations and different orientations; processing the images to detect the at least one obstacle, wherein the processing of an image of the images is responsive to a location and an orientation of the camera when the camera acquired the image.

15. The method according to claim 1 wherein the field of view of the camera corresponds to an angular area; wherein the method comprises determining, by the mobile device, which wireless tag out of the at least one wireless tag is a hidden wireless tag that is within the angular area but is behind an obstacle that is within the field of view of the camera.

16. The method according to claim 15 wherein the hidden wireless tag indication differs from the viewable wireless tag indication.

17. The method according to claim 15 comprising transmitting, by the wireless reader, a transmitted signal to a certain wireless tag of the at least one wireless tags; receiving a response signal from the certain wireless tag; and processing the response signal to determine whether the wireless tag is a hidden wireless tag.

18. The method according to claim 17 wherein the processing comprises calculating a first distance estimate in response to a timing difference between the transmitting and the receiving; calculating a second distance estimate in response to a strength parameter difference between the transmitted signal and the response signal; and comparing between the first and second distance estimate.

19. The method according to claim 1 wherein the field of view of the camera corresponds to an angular area; wherein the method comprises generating polar representation of the at least one locations of at least one wireless tag.

20. The method according to claim 19 comprising classifying each wireless tag of one of the at least one wireless tag in response to a relationship between the angular area and an angle between the wireless tag and an optical axis of the camera.

21. The method according to claim 19 comprising augmenting an image captured by the camera with each viewable wireless tag indication to provide an augmented image; wherein a position of each viewable wireless tag indication within the augmented image is responsive to (a) a distance between the camera and a wireless tag associated with the viewable wireless tag indication, and (b) an angle between an optical axis of the camera and a location of the viewable wireless tag.

22. The method according to claim 1 further comprising providing at least one out-of-sight image indication that is indicative of at least one image of at least one out-of-sight area that is outside the field of view of the camera; receiving a request to retrieve a certain out-of sight image and displaying the certain out-of-sight image.

23. The method according to claim 22 comprising augmenting an image that corresponds to the field of view of the camera with the out-of-sight image indication.

24. The method according to claim 23 wherein a position of each out-of-sight image indication within the augmented image is responsive to an angle between an optical axis of the camera and a location of the out-of-sight area.

25. The method according to claim 1 wherein the viewable wireless tag indication is indicative of an accuracy of an estimation of the location of the viewable wireless tag.

26. A non-transitory computer readable medium that stores instructions that once executed by a mobile device causes the mobile device to: determine, based upon wireless communication between a wireless reader of the mobile device and at least one wireless tag, at least one locations of the least one wireless tag; determine which wireless tag out of the at least one wireless tag is a viewable wireless tag that is within a field of view of a camera of the mobile device; and providing, by the mobile device, for each viewable wireless tag, a viewable wireless tag indication that is indicative of a location of each viewable wireless tag.

27. A mobile device that comprises a processor, a wireless reader, a camera and an interface; wherein the warless reader is configured to communicate with at least one wireless tag; wherein the device is configured to determine, based upon the communication, at least one location of the least one wireless tag; wherein the processor is configured to determine which wireless tag out of the at least one wireless tag is a viewable wireless tag that is within a field of view of a camera of the mobile device; and wherein the interface is configured to provide, for each viewable wireless tag, a viewable wireless tag indication that is indicative of a location of each viewable wireless tag.
